(19) United States
(12) Patent Application Publication
(10) Pub. No.: US 2017/0028778 A1
(43) Pub. Date: Feb. 2, 2017

(54) PNEUMATIC TIRE

(71) Applicant: TOYO TIRE & RUBBER CO., LTD., Osaka (JP)

(72) Inventor: Yuya Nishida, Osaka (JP)

(73) Assignee: TOYO TIRE & RUBBER CO., LTD., Osaka (JP)

(21) Appl. No.: 15/219,629

(22) Filed: Jul. 26, 2016

(30) Foreign Application Priority Data
Jul. 29, 2015 (JP) 2015-150096

(51) Int. Cl. B60C 9/20

(52) U.S. Cl. CPC B60C 9/20; B60C 2009/2016; B60C 2009/2061; B60C 2200/06

(57) ABSTRACT

A pneumatic tire has a belt layer arranged between a carcass and a tread portion. The belt layer has a first main working belt, a second main working belt arranged at an outer side of the first main working belt in a tire-radial direction, and a reinforcement belt. A cord angle of the second main working belt differs from a cord angle of the first main working belt in a direction with respect to a tire-circumferential direction. A cord angle of the reinforcement belt is not smaller than 6 degrees and not larger than 9 degrees. A width of the reinforcement belt is equal to or wider than 50% of a tire-section width and not wider than either narrower one of the first and second main working belts.

### CROSS-REFERENCE TO RELATED APPLICATIONS

This application claims priority of Japanese Patent Application No. 2015-150096 filed on Jul. 29, 2015, the content of which is incorporated herein by reference.

### BACKGROUND OF THE INVENTION

Technical Field

The present invention relates to a pneumatic tire.

Related Art

In a pneumatic radial tire for a heavy load used for a vehicle such as a truck or a bus, it has been known that a belt layer arranged between a carcass and a tread portion includes a reinforcement belt with cords having a small inclination angle with respect to the tire-circumferential direction (cord angle) of 0 to 5 degrees (see JP 2007-45334 A, JP 2005-104437 A, JP 2014-189243 A, Japanese Patent No. 5182455, for example). The reinforcement belt is intended to suppress a growth of the tire in the radial direction.

### SUMMARY

The small cord angle of the reinforcement belt ranging from approximately 0 to 5 degrees increases a force for holding a shape of the tread portion to reduce distortion at an end portion of the belt, and therefore is advantageous in view of belt durability.

However, the small cord angle of the reinforcement belt ranging from approximately 0 to 5 degrees causes an excessively large binding force in a tire-radial direction, thereby promoting an increased tendency in the deformation of a tire in the tire-width direction. The increased deformation in the tire-width direction increases the deformation of the tire at an area ranging from a bead portion to a portion having a largest width in a tire cross section. As a result, distortion in the bead portion is increased, causing lower resistance against a defect such as separation in the bead portion (bead durability).

It is an object of the present invention to provide a pneumatic tire where the bead durability is enhanced while ensuring an effect of suppressing a growth of the tire in a radial direction and belt durability.

An aspect of the present invention provides a pneumatic tire, comprising a belt layer arranged between a carcass and a tread portion, wherein the belt layer comprises, a first main working belt, a second main working belt arranged at an outer side of the first main working belt in a tire-radial direction, and a reinforcement belt, wherein a cord angle of the second main working belt differs from a cord angle of the first main working belt in a direction with respect to a tire-circumferential direction, wherein a cord angle of the reinforcement belt is not smaller than 6 degrees and not larger than 9 degrees, and wherein a width of the reinforcement belt is equal to or wider than 50% of a tire-section width and not wider than either narrower one of the first and second main working belts.

In this specification, the term “cord angle” is defined an acute angle which a cord of a belt or a ply forms with respect to a tire-circumferential direction. When the cord extends in the tire-circumferential direction, the cord angle is 0 degrees.

The cord angle of the reinforcement belt is set to a value not smaller than 6 degrees and not larger than 9 degrees, instead of setting the cord angle to a small angle such as an angle of not smaller than 0 degrees and not larger than 5 degrees (an angle substantially regarded as 0 degrees or an angle close to such angle). Such configuration can obviate a phenomenon where a binding force in a tire-radial direction generated by the reinforcement belt becomes excessively large, and therefore can suppress the excessively large deformation of the tire in the tire-width direction. As a result, the distortion generated in the bead portion can be suppressed, and therefore bead durability can be enhanced.

The cord angle of the reinforcement belt set to a value not smaller than 6 degrees and not larger than 9 degrees reduces an effect of suppressing a growth of the tire in the tire-radial direction compared to the case where the cord angle is set to a value not smaller than 0 degrees and not larger than 5 degrees. However, the cord angle of the reinforcement belt is allowed to take 9 degrees at maximum, and therefore there is no possibility that a binding force in the tire-radial direction is excessively reduced. Further, the width of the reinforcement belt is equal to or wider than 50% of a tire-section width. That is, the reinforcement belt has a sufficiently wide width instead of the narrow width. Due to the above-mentioned reasons, the tire can ensure a desired effect of suppressing a growth of the tire in the radial direction. Further, the tire can acquire a sufficient force for holding a shape of the tread portion so that distortion at an end portion of the belt can be reduced whereby the tire can ensure required belt durability. The width of the reinforcement belt is not wider than either narrower one of the first and second main working belts. Accordingly, the distortion generated in the reinforcement belt can be reduced.

As described above, according to the pneumatic tire of the present invention, bead durability can be enhanced while ensuring an effect of suppressing a growth of the tire in the radial direction and belt durability.

Preferably, the reinforcement belt is arranged between the first main working belt and the second main working belt.

Arranging the reinforcement belt between the first main working belt and the second main working belt can alleviate breakage of the cord in the vicinity of a road contact surface, and therefore cord breakage can be effectively prevented.

The cord angles of the first and second main working belts can be respectively 20±10 degrees. Further, the cord angles of the first and second main working belts can be respectively 17±5 degrees.

The belt layer can further comprise a protection belt arranged at an outer side of the second main working belt in the tire-radial direction.

The belt layer can further comprise a buffer belt arranged at an inner side of the first main working belt in the tire-radial direction.

The pneumatic tire can have an aspect ratio of not larger than 70% and a nominal section width of not smaller than 365.

According to the pneumatic tire of the present invention, bead durability can be enhanced while ensuring the effect of suppressing the growth of the tire in the radial direction and belt durability.

### BRIEF DESCRIPTION OF THE DRAWINGS

The foregoing and the other features of the present invention will become apparent from the following description and drawings of an illustrative embodiment of the invention in which:

FIG. 1 is a meridian sectional view of a pneumatic tire according to an embodiment of the present invention;

FIG. 2 is a development view of a belt layer;

FIG. 3 is a schematic partial sectional view of the pneumatic tire when a load is applied;

FIG. 4 is a meridian sectional view of a pneumatic tire according to a modification; and

FIG. 5 is a meridian sectional view of a pneumatic tire according to Comparative Example 1.

### DETAILED DESCRIPTION OF EMBODIMENTS

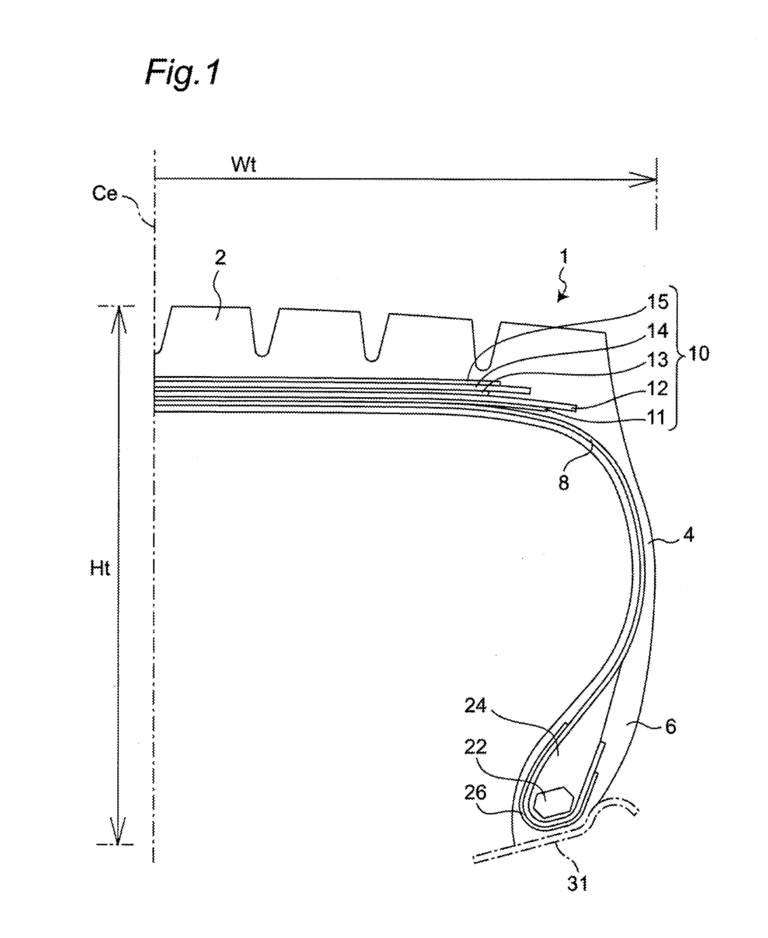

FIG. 1 shows a rubber pneumatic tire (hereinafter referred to as “tire”) 1 according to an embodiment of the present invention. The tire 1 is a pneumatic radial tire for a heavy load used for a vehicle such as a truck or a bus. Further, the tire 1 is a low-profile tire having an aspect ratio of not larger than 70%. An aspect ratio is defined as a ratio of a maximum tire-section height Ht to a maximum tire-section width Wt. Specifically, a size of the tire 1 in this embodiment is 445/50R22.5 (expressed in accordance with ISO standard).

The tire 1 includes a tread portion 2, a pair of side portions 4, and a pair of bead portions 6. The bead portions 6 are respectively formed on inner edge portions of the side portions 4 in a tire-radial direction (edge portions of the side portions 4 opposite to the tread portion 2). A carcass 8 is arranged between the pair of bead portions 6. An inner liner (not shown in the drawing) is arranged in an innermost peripheral surface of the tire 1. A belt layer 10 is arranged between the carcass 8 and a tread surface of the tread portion 2. In other words, in the tread portion 2, the belt layer 10 is arranged at an outer side of the carcass 8 in the tire-radial direction. As described later in detail, in this embodiment, the belt layer 10 includes five belts 11 to 15.

The bead portion 6 includes a bead core 22, a bead filler 24, and a chafer 26. Around the bead core 22, an end portion of the carcass 8 in a tire-width direction is wound up from an inner side to an outer side in a tire-width direction along the bead filler 24. The chafer 26 is arranged around the bead filler 24 so as to be arranged adjacently to an outer side of the end portion of the carcass 8.

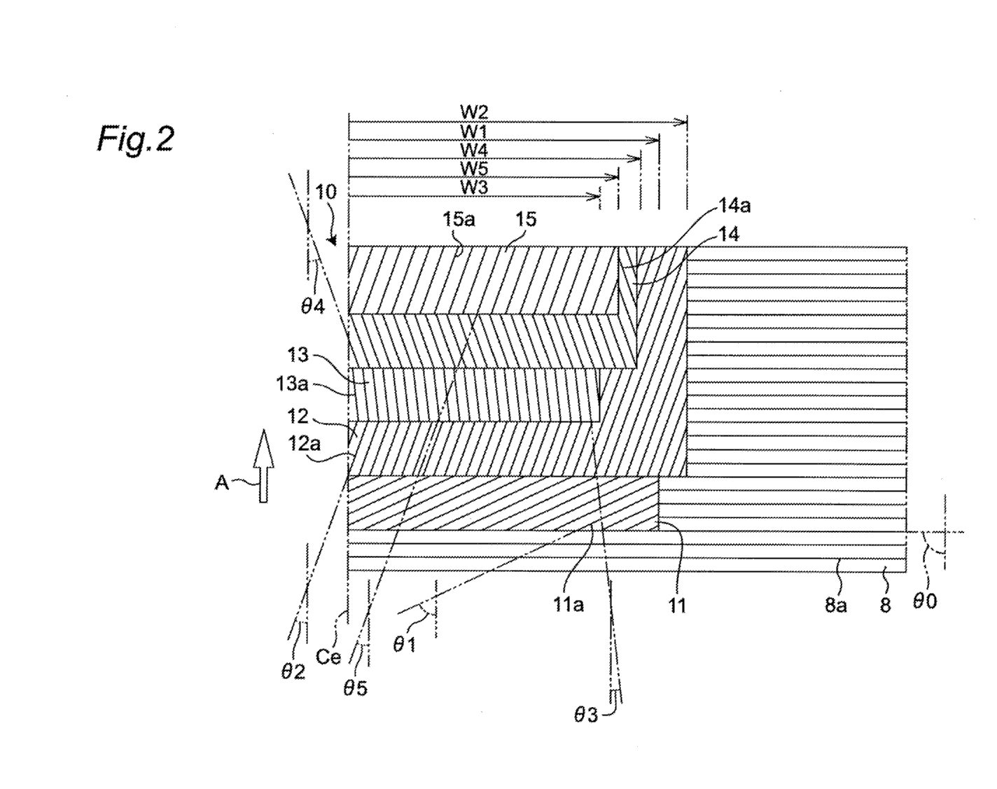

Referring to FIGS. 1 and 2, the carcass 8 in this embodiment is formed of one carcass ply, and is formed of a plurality of carcass cords 8a arranged parallel to each other and coated by a rubber layer. Each carcass cord 8a is arranged so as to extend in the tire-radial direction, and has an angle θ0 with respect to a tire-circumferential direction (cord angle) set to 90 degrees. In FIGS. 1 and 2, symbol Ce indicates a center line in the tire-width direction. The direction along which the center line Ce extends is a tire-radial direction. While the carcass cord 8a in this embodiment is made of steel, the carcass cord 8a can be made of organic fibers.

Referring to FIGS. 1 and 2, the belt layer 10 in this embodiment includes five belts arranged in an overlapping manner. These belts include a buffer belt 11, a first main working belt 12, a reinforcement belt 13, a second main working belt 14, and a protection belt 15.

The buffer belt 11 is arranged adjacently to an outer side of the carcass 8 in the tire-radial direction. The first main working belt 12 is arranged adjacently to an outer side of the buffer belt 11 in the tire-radial direction. The second main working belt 14 is arranged at an outer side of the first main working belt 12 in the tire-radial direction. The reinforcement belt 13 is arranged between the first main working belt 12 and the second main working belt 14. That is, the reinforcement belt 13 is arranged adjacently to the outer side of the first main working belt 12 in the tire-radial direction, and is also arranged adjacently to an inner side of the second main working belt 14 in the tire-radial direction. The protection belt 15 is arranged adjacently to an outer side of the second main working belt 14 in the tire-radial direction.

Main functions of the first and second main working belts 12 and 14 are to apply a binding force in the tire-radial direction to the carcass 8 (with a cord angle θ0 being set to 90 degrees). A main function of the reinforcement belt 13 is to compensate for the shortage in a binding force in the tire-radial direction which is applied to the tire 1 by the first and second main working belts 12 and 14. A main function of the protection belt 15 is to enhance external damage resistance of the tire 1 by protecting the first and second main working belts 12 and 14. A main function of the buffer belt 11 is to enhance impact resistance of the tire 1.

Each of these belts 11 to 15 is formed of a plurality belt cords 11a, 12a, 13a, 14a, and 15a arranged parallel to each other and coated by a rubber layer.

Referring to FIG. 2, inclination angles (cord angles) θ1 to θ5 of the belt cords 11a to 15a of belts 11 to 15 forming the belt layer 10 will be described. In the description hereinafter, regarding the cord angles θ1 to θ5, a direction along which the belt cords 11a to 15a extend rightward and away from the center line Ce in the tire-width direction when an arrow A in FIG. 2 is set as a reference direction can be referred to as “right upward direction”. Similarly, a direction along which the belt cords 11a to 15a extend leftward and away from the center line Ce in the tire-width direction when the allow A in FIG. 2 is set as the reference direction can be referred to as “left upward direction”.

In this embodiment, the cord angle 92 of the belt cord 12a of the first main working belt 12 is set to 17 degrees (right upward direction). The cord angle θ2 can be set to any value which falls within a range of 20±10 degrees, and can preferably be set to a value which falls within a range of 17±5 degrees.

In this embodiment, the cord angle θ4 of the belt cord 14a of the second main working belt 14 is set to 17 degrees (left upward direction). The cord angle θ4 can be set to a value which falls within a range of 20±10 degrees, and can preferably be set to a value which falls within a range of 17±5 degrees.

The cord angles θ2 and θ4 of the first and second main working belts 12, 14 are set so that the belt cords 12a and 14a extend in different directions with respect to the center line Ce in the tire-width direction. That is, one of the cord angles θ2 and θ4 is set so that the belt cords extend in the right upward direction, and the other of them is set so that the belt cords extend in the left upward direction.

The cord angle θ3 of the belt cord 13a of the reinforcement belt 13 is set to 7 degrees (left upward direction) in this embodiment. The cord angle θ3 can be set to a value which falls within a range of not smaller than 6 degrees and not larger than 9 degrees.

The cord angle θ1 of the belt cord 11a of the buffer belt 11 is set to 65 degrees in this embodiment. The cord angle θ1 can be set to a value which falls within a range of 60±15 degrees.

The cord angle θ5 of the belt cord 15a of the protection belt 15 is set to 20 degrees in this embodiment. The cord angle θ5 can be set to a value which falls within a range of 20±10 degrees.

Numerical values (including upper and lower limit values of a numerical value range) of the cord angles θ1 to θ5 can include substantially unavoidable errors, and are not necessarily geometrically precise values as long as that functions required for the belts 11 to 15 are satisfied. This is also applied to the cord angle θ0 of the carcass cords 8a.

The cord angles θ1 to θ5 of the belts 11 to 15 can be coordinated as shown in the following Table 1.

TABLE 1

| | Embodiment | Settable range of angle |
|---|---|---|
| Buffer belt | 65 degrees | 60 ± 15 degrees |
| | (right upward direction) | (right upward direction) |
| First main working belt | 17 degrees | 20 ± 10 degrees (17 ± 5 degrees) |
| | (right upward direction) | (right upward direction) |
| Reinforcement belt | 7 degrees | Not smaller than 6 degrees and not |
| | (left upward direction) | larger than 9 degrees |
| Second main working belt | 17 degrees | 20 ± 10 degrees (17 ± 5 degrees) |
| | (left upward direction) | (right upward direction) |
| Protection belt | 20 degrees | 20 ± 10 degrees |
| | (right upward direction) | (right upward direction) |

Main data except for the cord angles of the belts 11 to 15 in this embodiment are shown in the following Table 2.

TABLE 2

| | | | Thickness | | |
|---|---|---|---|---|---|
| | | | of cord | | |
| | | Diameter | including | Number | |
| | | of | cover | of | |
| | Raw | cord | rubber | ends | Width |
| | material | (mm) | (mm) | (EPI) | (mm) |
| Buffer belt | Steel | 1.1 | 1.7 | 12 | W1 = 345 |
| First main working | Steel | 1.4 | 2.6 | 12 | W2 = 370 |
| belt | | | | | |
| Reinforcement belt | Steel | 1.1 | 1.7 | 12 | W3 = 290 |
| Second main | Steel | 1.4 | 2.6 | 12 | W4 = 325 |
| working belt | | | | | |
| Protection belt | Steel | 1.1 | 1.9 | 9 | W5 = 295 |

As shown in Table 2, in this embodiment, a width W4 (325 mm) of the second main working belt 14 which is arranged relatively outer side in the tire-radial direction is set narrower than a width W2 (370 mm) of the first main working belt 12 which is arranged relatively inner side in the tire-radial direction.

A width W3 of the reinforcement belt 13 is set to a value equal to or wider than 50% of a maximum tire-section width Wt (W3≧0.5 Wt). In this embodiment, the maximum tire-section width Wt is a value set under conditions where the tire 1 is mounted on a predetermined rim (a rim 31 is schematically shown in FIG. 1), the tire 1 is filled with air until an inner pressure reaches a predetermined internal pressure (830 kPa which is an internal pressure determined by the Tire and Rim Association, Inc (TRA)), and the tire 1 is in an unloaded state. The width W3 of the reinforcement belt 13 is set narrower than a width of either one of the first and second main working belts 12 and 14 having a narrower width than the other (W3<W2, W4). In this embodiment, the width W3 of the reinforcement belt 13 is set to 290 mm. Accordingly, the width W3 of the reinforcement belt 13 is equal to or wider than 50% of a maximum tire-section width Wt (440 mm) under the above-mentioned conditions, and is narrower than the width W4 (325 mm) of the second main working belt 14 having a narrower width.

The cord angle θ3 of the reinforcement belt 13 is set to an angle of not smaller than 6 degrees and not larger than 9 degrees, instead of a small angle of not smaller than 0 degrees to not more than 5 degrees (an angle which can be substantially regarded as 0 degrees or an angle close to 0 degrees). Such configuration can prevent a binding force in a tire-radial direction generated by a reinforcement belt 13 from becoming excessively large, and therefore the excessively large deformation of the tire in the tire-width direction can be suppressed. Since the excessively large deformation of the tire in the tire-width direction can be suppressed, the distortion generated in the bead portion 6 can be suppressed, and therefore bead durability (resistance against the generation of a defect such as separation in the bead portion) can be enhanced.

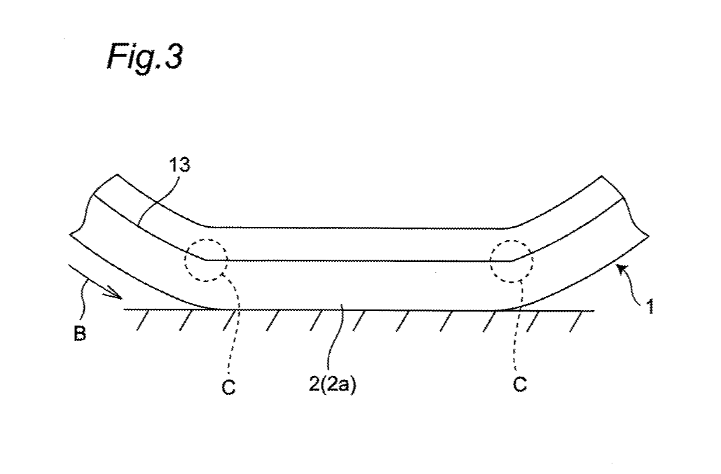

As conceptually shown in FIG. 3, in a loaded state (a state where the tire 1 is mounted on a vehicle), belt cords 13a of the reinforcement belt 13 are bent in regions (symbols C) of a tread surface of the tread portion 2 in front of and behind a road contact surface 2a in the rotational direction of the tire indicated by an arrow B. The smaller cord angle θ3, the more conspicuous the bending of the belt cords 13a becomes. By setting the cord angle θ3 to a value not smaller than 6 degrees and not larger than 9 degrees, compared to a case where the cord angle θ3 is set to a small angle such as an angle not smaller than 0 degrees and not larger than 5 degrees, bending of the belt cord 13a of the reinforcement belt 13 in the vicinity of the road contact surface 2a can be alleviated, and therefore cord breakage can be effectively prevented.

As described above, the width W3 of the reinforcement belt 13 is set narrower than the width W4 of the second main working belt 14 which is narrower one of the first and second main working belts 12, 14. Such configuration can also effectively prevent cord breakage of the belt cord 13a of the reinforcement belt.

As described above, the reinforcement belt 13 is arranged between the first main working belt 12 and the second main working belt 14. Due to such an arrangement, the reinforcement belt 13 is protected by the first and second main working belts 12, 14, and therefore cord breakage of the belt cord 13a of the reinforcement belt 13 caused due to bending of the cord in the vicinity of the road contact surface 2a (symbols C in FIG. 3) can be effectively prevented.

Due to these reasons, cord breakage of the reinforcement belt 13 can be effectively prevented.

By setting the cord angle θ3 of the reinforcement belt 13 to a value not smaller than 6 degrees and not larger than 9 degrees, an effect of suppressing a growth of the tire 1 in the radial direction is reduced compared to the case where the cord angle θ3 is set to a value not smaller than 0 degrees and not larger than 5 degrees. However, the cord angle θ3 of the reinforcement belt 13 is 9 degrees at maximum, and therefore there is no possibility that a binding force in the tire-radial direction is excessively reduced. Further, as described above, the width W3 of the reinforcement belt 13 is equal to or wider than 50% of a maximum tire-section width Wt. That is, a width of the reinforcement belt 13 is not narrow but is sufficiently wide. Due to these reasons, the tire 1 can ensure a required effect of suppressing a growth of the tire 1 in the radial direction. Further, the tire can acquire a sufficient force for holding a shape of the tread portion 2 so that distortion at the end portion of the belt can be reduced whereby the tire can ensure required belt durability. The width W3 of the reinforcement belt 13 is narrower than a width of the narrower one of the first and second main working belts 12 and 14 (widths W2, W4). Accordingly, the distortion generated in the reinforcement belt 13 can be reduced.

As described above, according to the tire 1 of the present embodiment, bead durability can be enhanced while an effect of suppressing a growth of the tire 1 in the radial direction and belt durability are also ensured.

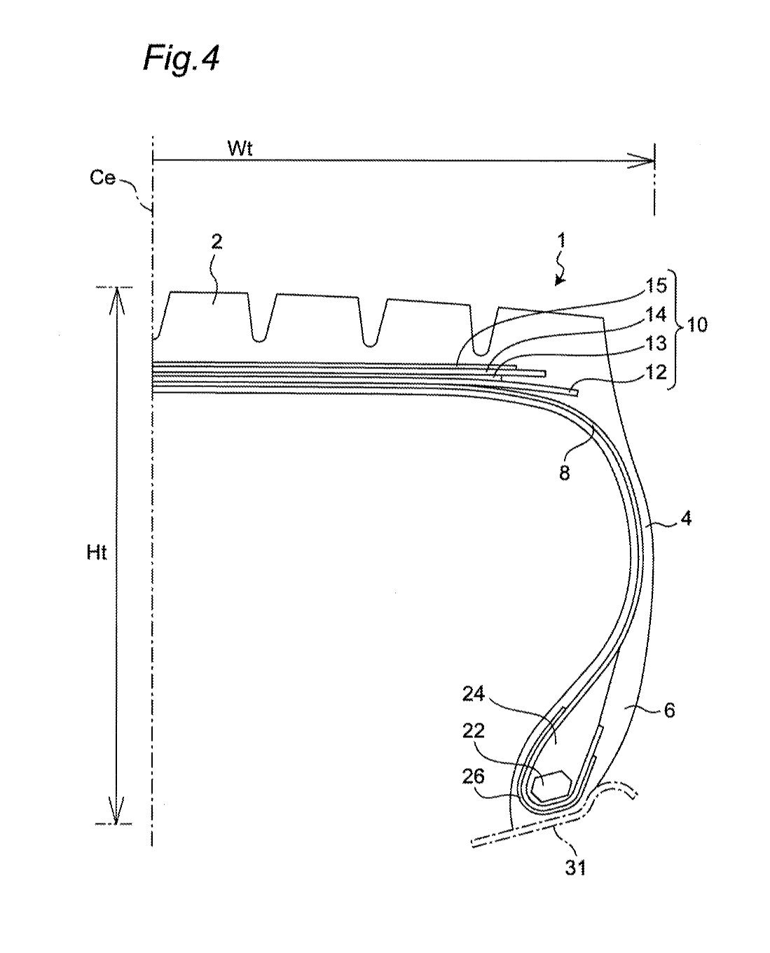

FIG. 4 shows a modification of the tire 1 according to the embodiment. In this modification, a belt layer 10 includes four belts, that is, a first main working belt 12, a reinforcement belt 13, a second main working belt 14, and a protection belt 15, but does not include a buffer belt 11. Even in the case where the belt layer 10 does not include the buffer belt 11, bead durability can be enhanced while an effect of suppressing a growth of the tire 1 in the radial direction and belt durability are also ensured.

### EXAMPLES

Tires according to Comparative Examples 1 to 5 and tires according to Examples 1 to 4 shown in the following Table 3 were subjected to an evaluation test performed for evaluating belt durability and bead durability. Assume that data which are not described particularly hereinafter are shared in common by the tires according to Comparative Examples 1 to 5 and the tires according to Examples 1 to 4. Particularly, in all of Comparative Examples 1 to 5 and the tires according to Examples 1 to 4, a tire size is set to 445/50R22.5.

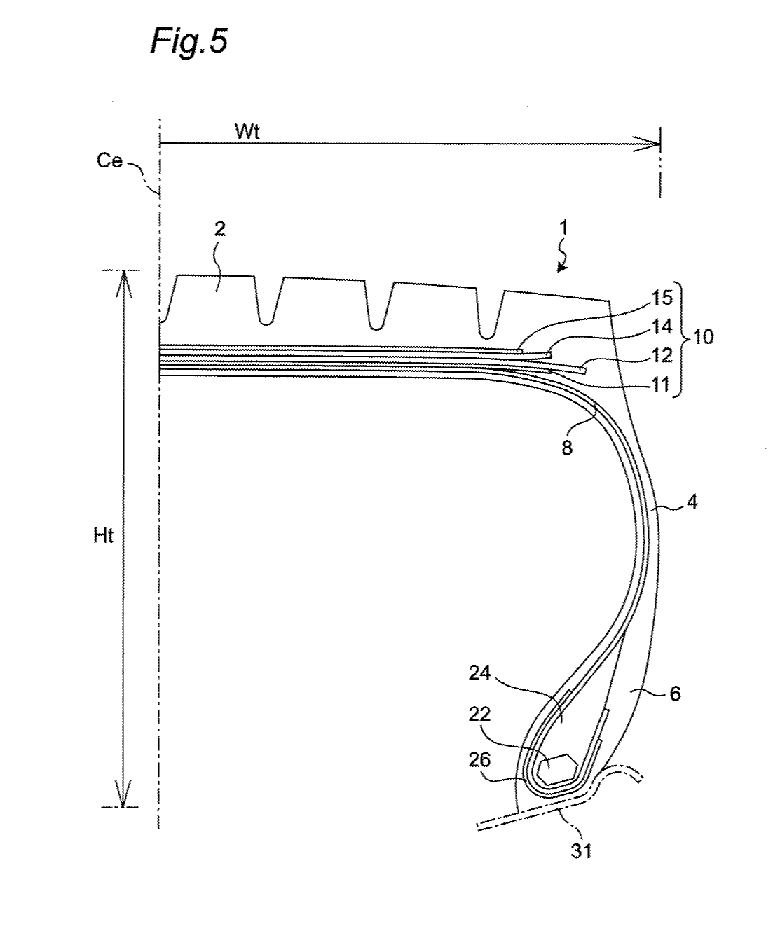

TABLE 3

| | Comparative | Comparative | Comparative | Comparative | Comparative |
|---|---|---|---|---|---|
| | Example 1 | Example 2 | Example 3 | Example 4 | Example 5 |
| Note | No | Reinforcement | Cord angle | Cord angle | Width W3 |
| | reinforcement | belt extending in | θ3 | θ3 | excessively |
| | belt | circumferential | excessively | excessively | small |
| | (FIG. 5) | direction | small | large | |
| Cord angle θ3 | — | 0 | 5 | 10 | 7 |
| (degrees) of | | | | | |
| reinforcement | | | | | |
| belt | | | | | |
| Width W3 of | — | 290 | 290 | 290 | 180 |
| reinforcement | | | | | |
| belt | | | | | |
| (mm) | | | | | |
| W3/Wt*100(%) | — | 66 | 66 | 66 | 41 |
| Belt durability | 100 | 130 | 127 | 105 | 90 |
| Bead durability | 100 | 90 | 100 | 120 | 100 |

| | Example 1 | Example 2 | Example 3 | Example 4 |
|---|---|---|---|---|
| Note | Cord angle θ3 | Cord angle θ3 | Cord angle | Width W3 |
| | being lower | being a value | θ3 being | being lower |
| | limit value | close to center | upper limit | limit value |
| | | value | value | |
| Cord angle θ3 | 6 | 7 | 9 | 7 |
| (degrees) of | | | | |
| reinforcement | | | | |
| belt | | | | |
| Width W3 of | 290 | 290 | 290 | 220 |
| reinforcement | | | | |
| belt | | | | |
| W3/Wt*100(%) | 66 | 66 | 66 | 50 |
| Belt durability | 123 | 120 | 110 | 110 |
| Bead durability | 110 | 115 | 120 | 105 |

A belt layer 10 according to Comparative Example 1 shown in FIG. 5 does not include a reinforcement belt 13, but includes a buffer belt 11, a first main working belt 12, a second main working belt 14, and a protection belt 15.

In the tire according to Comparative Example 2, a cord angle θ3 of a reinforcement belt 13 is set to 0 degrees, which is smaller than a lower limit value of a range of a cord angle θ3 (not smaller than 6 degrees and not larger than 9 degrees) in the present invention.

In the tire according to Comparative Example 3, a cord angle θ3 of a reinforcement belt 13 is set to 5 degrees, which is smaller than the lower limit value of the range of the cord angle θ3 (not smaller than 6 degrees and not larger than 9 degrees) in the present invention.

In the tire of Comparative Example 4, a cord angle θ3 according to a reinforcement belt 13 is set to 10 degrees, which is larger than an upper limit value of the range of the cord angle θ3 (not smaller than 6 degrees and not larger than 9 degrees) in the present invention.

In the tire according to Comparative Example 5, a width W3 of a reinforcement belt 13 is set to 180 mm. A tire 1 is mounted on a predetermined rim, the tire is filled with air until a tire internal pressure reaches a predetermined internal pressure, and a maximum tire-section width in an unloaded state is set to 440 mm. Accordingly, in Comparative Example 5, a ratio of the width W3 of the reinforcement belt 13 to a maximum tire section width Wt is 41%. Accordingly, the width W3 of the reinforcement belt 13 according to Comparative Example 5 is narrower than a lower limit value of a width W3 of the reinforcement belt 13 (W3=0.5 Wt) in the present invention.

In the tire of Example 1, a cord angle θ3 of a reinforcement belt 13 is set to 6 degrees, which is the lower limit value of the range of the cord angle θ3 (not smaller than 6 degrees and not larger than 9 degrees) in the present invention.

In the tire according to Example 2, a cord angle θ3 of a reinforcement belt 13 is set to 7 degrees, which is a value close to a center value of the range of the cord angle θ3 (not smaller than 6 degrees and not larger than 9 degrees) in the present invention.

In the tire according to Example 3, a cord angle θ3 of a reinforcement belt 13 is set to 9 degrees, which is the upper limit value of the range of the cord angle θ3 (not smaller than 6 degrees and not larger than 9 degrees) in the present invention.

In the tire according to Example 4, a width W3 of a reinforcement belt 13 is set to 220 mm. As described later, a maximum tire-section width under the conditions of the evaluation test is set to 440 mm. Accordingly, a ratio of the width W3 of the reinforcement belt 13 in Example 4 to the maximum tire-section width Wt is 50%. That is, the width W3 of the reinforcement belt 13 in Example 4 is a lower limit value of the width W3 of the reinforcement belt 13 (W3=0.5 Wt) in the present invention.

In this evaluation test, belt durability and bead durability are evaluated.

In evaluating belt durability, each tire has a tire size of 445/50R22.5, the tire is mounted on a wheel having a rim size of 22.5×14.00 (specified rim), and the tire is filled with air having a pressure of 930 kPa (a value obtained by adding 100 kPa to 830 kPa which is an internal pressure determined by TRA). Each tire mounted on the wheel is mounted on a drum tester, and a traveling test is performed under conditions where a speed is set to 40 km/h and a load is set to 54.4 kN. In such a case, traveling distances of respective tires before the tires are broken are expressed as indexes respectively as shown in Table 3.

In evaluating bead durability, each tire has a tire size of 445/50R22.5, the tire was mounted on a wheel having a rim size of 22.5×14.00 (specified rim), and the tire was filled with air having a pressure of 900 kPa (a value obtained by adding 70 kPa to 830 kPa which is an internal pressure specified by TRA). Each tire mounted on the wheel was mounted on a drum tester, and a traveling test, was performed under conditions where a speed is set to 40 km/h and a load is set to 72.5 kN. In such a case, traveling distances of respective tires before the tires were broken are expressed as indexes respectively as shown in Table 3.

An internal pressure of air filled in the tire and a load applied to the tire differ between the evaluation of belt durability and the evaluation of bead durability. The reason is that the condition that distortion is liable to be generated in the belt layer 10 is adopted in the evaluation of belt durability, while the condition that distortion is liable to be generated in the bead portion 6 is adopted in evaluation of bead durability.

In both belt durability and bead durability, assuming the performance of the tire according to Comparative Example 1 as 100, performances of tires according to the remaining Comparative Examples 2 to 5 and Examples 1 to 4 are indexed.

In all Examples 1 to 4, the indexes of belt durability are not smaller than 110, showing that all tires have favorable belt durability. In all Examples 1 to 4, indexes of bead durability are not smaller than 105, showing that the tires can have favorable bead durability.

In the tires according to Comparative Examples 2 and 3 where the cord angles θ3 of the reinforcement belt 13 are lower than a lower limit value of the range of the cord angle θ3 (not smaller than 6 degrees and not larger than 9 degrees) in the present invention, although indexes of belt durability exceed 110, indexes of bead durability are lower than 105. That is, in the case where a cord angle θ3 of a reinforcement belt 13 is set to an angle smaller than a value which falls within the range of the cord angle θ3 according to the present invention, even when a tire has the same belt durability as the tires according to Examples 1 to 4, the tire cannot acquire sufficient bead durability.

In the tire according to Comparative Example 4 where the cord angle θ3 of the reinforcement belt 13 exceeds the upper limit value of the range of the cord angle θ3 (not smaller than 6 degrees and not larger than 9 degrees) of the present invention, although an index of bead durability exceeds 105, an index of belt durability is lower than 110. That is, in the case where the cord angle θ3 of the reinforcement belt 13 is set to an angle larger than a value which falls within the range of the present invention, even when a tire has the same bead durability as the tires of Examples 1 to 4, the tire cannot acquire sufficient belt durability.

In the tire according to Comparative Example 5 where a ratio of a width W3 of the reinforcement belt 13 to a maximum tire-section width Wt is lower than the lower limit value of the range (equal to or wider than 50% of maximum tire-section width) in the present invention, an index of bead durability is lower than 105, and an index of belt durability is lower than 110. That is, when the width W3 of the reinforcement belt 13 is narrower than a value which falls within the range of the present invention, the tire cannot acquire sufficient bead durability and sufficient belt durability.

As described above, by comparing the tires according to Comparative Examples 1 to 5 and the tires according to Examples 1 to 4, it is understood that, according to the present invention, bead durability can be enhanced while belt durability in the pneumatic tire is also ensured.

The tire according to the present invention is favorably applicable to a pneumatic tire (so-called super single tire) having an aspect ratio of not larger than 70% and a nominal section width of not smaller than 365. The tire according to the present invention is also applicable to a pneumatic tire having a small aspect ratio and falling outer side a range of a pneumatic radial tire for heavy load.

What is claimed is:

1. A pneumatic tire, comprising a belt layer arranged between a carcass and a tread portion,
wherein the belt layer comprises:
a first main working belt;
a second main working belt arranged at an outer side of the first main working belt in a tire-radial direction; and
a reinforcement belt,
wherein a cord angle of the second main working belt differs from a cord angle of the first main working belt in a direction with respect to a tire-circumferential direction,
wherein a cord angle of the reinforcement belt is not smaller than 6 degrees and not larger than 9 degrees, and
wherein a width of the reinforcement belt is equal to or wider than 50% of a tire-section width and not wider than either narrower one of the first and second main working belts.

2. The pneumatic tire according to claim 1, wherein the reinforcement belt is arranged between the first main working belt and the second main working belt.

3. The pneumatic tire according claim 1, wherein the cord angles of the first and second main working belts are respectively 20±10 degrees.

4. The pneumatic tire according to claim 3, wherein the cord angles of the first and second main working belts are respectively 17±5 degrees.

5. The pneumatic tire according to claim 1, wherein the belt layer further comprises a protection belt arranged at an outer side of the second main working belt in the tire-radial direction.

6. The pneumatic tire according to claim 5, wherein the belt layer further comprises a buffer belt arranged at an inner side of the first main working belt in the tire-radial direction.

7. The pneumatic tire according to claim 1, wherein the pneumatic tire has an aspect ratio of not larger than 70% and a nominal section width of not smaller than 365.
